(19) United States
(12) Patent Application Publication
(10) Pub. No.: US 2010/0163789 A1
(43) Pub. Date: Jul. 1, 2010

(54) CALCIUM CARBONATE SCALE INHIBITOR AND REMOVER FOR FRESHWATER AND SEAWATER FLUSHED SANITARY WASTE SYSTEMS

(76) Inventor: Thomas F. D'Muhala, Raleigh, NC (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/647,651

(22) Filed: Dec. 28, 2009

Related U.S. Application Data
(60) Provisional application No. 61/141,261, filed on Dec. 30, 2008.

(51) Int. Cl. C02F 5/10

(52) U.S. Cl. 252/175

(57) ABSTRACT

A powder formulation containing biodegradable organic compounds which will not bioaccumulate or pollute, allow for the safe and effective room temperature elimination of scale from freshwater and seawater flushed toilets and sanitary waste systems. The formulation mixes readily with water and removes only scales and deposits, not the underlying materials of construction. The formulation is non-toxic, non-caustic, non-flammable, and contains no mineral acids.

### CROSS-REFERENCE TO RELATED APPLICATIONS

The present application claims priority to U.S. Provisional Application 61/141,261 filed Dec. 30, 2008.

### BACKGROUND OF THE INVENTION

1. Field of the Invention

The invention is directed to a mildly acidic blend of nontoxic, biodegradable, organic compounds, which displays the same activity as mineral acids, without the attendant hazards associated with these harsh materials.

2. Description of the Prior Art

Mineral acid formulations have been used for cleaning and descaling purposes. Mineral acids do not contain carbon atoms. Exemplary mineral acids include sulfuric acid, nitric acid hydrochloric acid, and boric acid. However, these formulations are dangerous to the user and to the environment, and can also breakdown the materials used in the system to be cleaned.

### SUMMARY OF THE INVENTION

It is an object of this invention to provide a safe and effective composition for inhibiting and removing calcium carbonate scale from freshwater and seawater flushed sanitary systems used on ships and boats, including, for example, navy ships and cruise ships, and used in land based facilities, including for example, hotels, resorts, and commercial, office, and industrial buildings.

According to the invention, an acidic blend of non-toxic, biodegradable organic compounds has been prepared which safely removes calcium carbonate scales and encrustations at ambient temperature. The blend, referred to as “INTEK-CHTC”, is a chelant based formula that inhibits and removes calcium carbonate scale. The product also interacts with polyvalent metal ions (e.g., calcium) in the waste stream, and effectively inhibits their precipitation as scaling factors. INTEK-CHTC effectively removes and inhibits scale in sanitary lines without attacking materials of construction, equipment, or enzymatic or microbiotic treatments.

INTEK-CHTC is a non-dusting powder that readily dissolves in water and is easily administered using conventional automatic chemical injection or hand feed methods. Once dissolved, there are no special precautions required for handling or dealing with chemical odors or fumes. In addition, the formulation used in INTEK-CHTC offers substantial savings by eliminating the unnecessary packaging and shipping of water associated with aqueous products and by eliminating unnecessary drum disposal costs.

### DETAILED DESCRIPTION

INTEK CHTC (The Product) was developed to comply with MIL-PRF-32217, 27 Jul. 2006, “SCALE PREVENTION IN SEWAGE COLLECTION, HOLDING AND TRANSFER (CHT) AND VACUUM CHT (VCHT) PIPING SYSTEMS FOR USE ON NAVAL SURFACE SHIPS”, the contents of which are herein incorporated by reference. Meeting MIL-PRF-32217 requirements is a balancing act between pH, corrosion of metals and alloys, compatibility with synthetics and non-metallics, environmental and personnel safety, storage footprint, shelf-life, and performance (inhibiting scale formation, precipitation and adherence, within seconds of addition, with a limit of one addition per day). Although not mentioned in MIL-PRF-32217, other considerations must include product cost and availability.

INTEK CHIC is a blend of an organic acid, organic acid salts, corrosion inhibitors, and an organic dye, designed to inhibit deposition and adherence of calcium carbonate scale in freshwater, and seawater, flushed shipboard sanitary waste systems, and to remove existing deposits of same, without adverse impact on shipboard personnel, the environment, or metallic or synthetic materials of system construction. INTEK CHTC can also be used in a variety of other applications including land based facilities including, for example, hotels, resorts, and commercial, office and industrial buildings.

An optimum formulation includes the following ingredients and is made by the following procedures:

| | % BY |
|---|---|
| INGREDIENT | WEIGHT |
| 2-Hydroxy-1,2,3-propanetricarboxylic acid, monohydrate | 48.70 |
| 2-Hydroxy-1,2,3-propanetricarboxylic acid, | 32.25 |
| trisodium salt, dehydrate | |
| Glycine, N,N′-1,2-ehtanediylbis | 15.97 |
| [N-(carboxymethyl)-tetrasodium salt, dehydrate | |
| 1,2,3-Benzotriazole (powder), e.g., Cobratec 99 (powder) | 0.97 |
| CORTEC S-11 (Powder) | 1.10 |
| RODINE 95 (Liquid) | 0.97 |
| FD&C BLUE #1 DYE (Powder) | 0.04 |
| TOTAL | 100.00% |

The optimum formulation complies with MIL-PRF 322217. However, a suitable organic acid based descaling product, which may or may not comply with all of the criteria of MIL-PRF 322217 can be prepared by

I) altering any or all of the ingredients by approximately as much as 5-10% by weight. For example, 2-Hydroxy-1,2,3-propanetricarboxylic acid, monohydrate could range from 43 to 53 wt %; 2-Hydroxy-1,2,3-propanetricarboxylic acid, trisodium salt, dehydrate could range from 27 to 37 wt %; Glycine, N,N′-1,2-ehtanediylbis[N-(carboxymethyl)-tetrasodium salt, dehydrate (or other organic acids or organic acid salts) could range from 10 to 21 wt % up to 10% corrosion inhibitors (e.g. Cortec and Rodine), etc.

II) Substituting or adding different colored dyes. FD&C Blue #1 is a product of Pylam. Products company, Inc. Examples of other possible dyes include FD&C Red #3, S 318 Pylaklor Golden Yellow, S 720 Pylaklor Permanent Blue, and Pylaklor Permanent Turqoise Green, all of which are products of the Pylam Products Company, Inc. In addition, Red Food Color Rouge VIF, a product of Preema Int. Ltd. might also be used.

III) Substituting or adding different corrosion inhibitors. CORTEC S-11 is a product of CORTEC Corporation, and is a proprietary blend of acetylenic alcohols, salts of quaternary amines, and nonionic surfactants. RODINE 95 is a product of Henkel Surface Technologies, is a blend of substituted triazine (40-50%), ethylene glycol (1-10%), hydrochloric acid (1-10%), thiourea (1-5%), and water. Examples of other possible corrosion inhibitors include COBRATEC 99 which is a product of PMC Specialties, Inc., that is 1,2,3-Benzotriazole; ARMOHIB 31, a product of AKZO Nobel, which is a proprietary blend of alkoxylated fatty amine, alkoxylated organic acid, and thiourea, N,N′-dibutyl (20-30%); RODINE 100 (Powder), a product of Parker/Amchem-Henkel Corp.; RODINE 103 (Liquid), a product of Parker/Amchem-Henkel Corp. which is a blend of ethylene dihydroiodide (1-10%), iodine complex (1-10%), phosphoric acid (1-10%), surfactants (1-10%), and water; COBRATEC TT-50-S, a product of PMC Specialties, Inc., which is tolyltriazole, sodium salt; and ANCOR CR-539, a product of Air Products and Chemicals. Inc., which is a proprietary acetylenic alcohol-based inhibitor.

IV) Substituting or adding different organic acids or organic acid salts. Suitable examples of organic acids which may be added to the formulation or used as substitutes include glycolic acid, sulfamic acid, ethylenediaminetetraacetic acid, and nitrilotriacetic acid. Suitable examples of organic acid salts which may be added to the formulation or used as substitutes include potassium or sodium salts of glycolic acid; Glycine, N,N′-1,2-ehtanediylbis[N-(carboxymethyl)-disodium salt; Glycine, N,N′-1,2-ehtanediylbis[N-(carboxymethyl)-tetrapotassium salt; Glycine, N,N′-1,2-ehtanediylbis[N-(carboxymethyl)-dipotassium salt; Potassium or sodium salts of Nitrilotriacetic acid; and 2-Hydroxy-1,2,3-propanetricarboxylic acid, tripotassium salt.

An important feature of the invention is that the descaling composition is free of mineral acids. The optimum formulation set forth above has the following specifications:

| | |
|---|---|
| Appearance: | White (or light blue) crystalline |
| | powder with blue specks |
| pH (of 1% solution): | 3.92 ± 0.05 |
| Bulk Density: | 41.65 ± 0.45 lbs/ft³ |

The optimum formulation set forth above is preferably made by the following PROCEDURE:
1. Add ingredients to a commercial powder blender in the order given;
2. Unless otherwise noted, do not use substitutes.
3. Blend for at least 30 minutes, but less than 45 minutes, preferably reversing the direction of rotation at least twice during this blend period;
4. Package and seal immediately after blending.

INTEK-CHTC should be blended in a dry facility and powder blender, under very low humidity conditions (e.g., in an air-conditioned or dehumidified facility, or on a sunny, very low humidity day).

Within 24 hours after blending, INTEK-CHTC may crust-over, or cake, depending on the adequacy of dehumidification or air conditioning employed, both prior to, and during, ingredient loading, and final product blending and packaging. Therefore, it may become necessary to re-blend the product for an additional 15 to 30 minutes, prior to final packaging and container sealing. Re-blending would render the product a light blue crystalline powder with blue specks. Once re-blended, the product will not crust-over or cake again since it would be partially hydrated.

Preferably, RODINE 99 (Liquid) is added by broadcasting (spraying or sprinkling) across the surface of the other powdered ingredients in the powder blender immediately before activating the blender.

INTEK-CHTC preferably should be packaged and sealed in polyethylene containers or heavy-duty polyethylene bags (>3 mil) that are set within polyethylene, fiberboard or metal containers. This product preferably should be supplied in an UN certified 1H1, Open Top, High Density Polyethylene Drum. This packaging meets all regulations governing transportation via ground, air and sea. The product may also be supplied in 5-Gallon, 8-Pound or 2.5 Pound HDPE polyethylene containers or heavy-duty polyethylene bags (>3 mil) set within fiberboard or metal containers. INTEK-CHTC is preferably stored below 70° C. (158° F.).

The INTEK-CHTC product is preferably introduced into the shipboard piping system by adding about 53 grams of the powder to each toilet or urinal on the ship (preferably once a day). As the formulation can be an irritant to skin, protective eyewear and gloves are recommended during use, and efforts should be made to reduce the amount of dust generated when scooping. Once the powder is dissolved in a toilet, the toilet is flushed.

### EXAMPLES

### Example 1

### pH Testing

INTEK-CHTC, according to the optimum formulation set forth above is require to have a pH in a diluted test sample of water between 3.0 and 8.5 in order to meet the MIL-PRF-32217 requirement for pH.

A dose of INTEK-CHTC (53 grams—the recommended amount to be used in a single sanitary fixture) was combined with two one-gallon samples of freshwater and two one-gallon samples of seawater (natural seawater or synthetic with a minimum salinity of 3.2 wt %). A portion of the test sample was diluted tenfold and the pH measured. Table 1 shows that the pH testing fell well within the desired pH range.

| Sample | pH |
|---|---|
| Freshwater A | 5.2 |
| Freshwater B | 5.5 |
| Seawater A | 5.0 |
| Seawater B | 5.1 |

### Example 2

### Foam Test

A single dose of INTEK-CHTC, as described above, was combined with one gallon of water. 200 ml of water was withdrawn and poured into a 16 oz round bottle. A thermocouple was used to ensure that the test liquid was 25° C. The initial height of the liquid (I) was marked and recorded to the nearest 1 mm. A second mark was placed 10 mm above the initial height. The bottle was shaken vigorously with a minimum of an eight inch stroke and forty shakes in less than ten seconds. The maximum height after shaking (M) was recorded and the time started. The bottle was allowed to stand undisturbed for five minutes, and the time (T) was recorded at which the foam subsided to a net foam height of 10 mm. After the five minute wait period, the total height was recorded to the nearest 1 mm and referred to as the residual total height (R). The residual foam height, Fᵣ, was determined as R-I. Only freshwater was used for this test. The test was performed using two separate chemical solutions with the sample from each solution produced being performed in triplicate.

As desired, and in compliance with MIL-PRF-32217, the residual foam height Fᵣ after the five minute settling time was less than or equal to 9.65 mm.

### Example 3

### Corrosion (Metals)

A single dose of INTEK-CHTC, as described above, was combined with one gallon of water. This test solution was used for copper-nickel (CuNi), bronze and copper specimens. A portion of the test solution was diluted with water tenfold and used for the aluminum and zinc specimens.

Metal samples were cut into squares of approximately 10 centimeters in area. These samples were ground using 60 grit abrasive paper to eliminate variations in condition of the original metallic surfaces. The area of each sample was measured using calipers, and the initial weight was recorded to the nearest 0.1 mg. The samples were then placed upright in jars containing approximately 500 ml of the solution and a timer was started. At 24, 48, and 72 hour intervals, the metal samples were removed from the solutions, rinsed, dried and re-weighed. The corrosion rate of each sample was measured using the following formula: corrosion rate (mils per year)=KW/ATD; where K=a constant (3.45×10⁶); W=mass loss to the nearest milligram; A=area to the nearest 0.01 square centimeter; T=time of exposure to the nearest 0.01 hours; and D=density in grams/cubic centimeter. The test was performed using two separate chemical solutions, with the solution produced from each packet being performed in triplicate. Results are reported as an average of the triplicate samples. An identical evaluation with synthetic or natural seawater was also performed. The salinity of the seawater was a minimum of 3.2 wt %.

The permissible corrosion rates for both freshwater and seawater diluted samples are equal to or less than the rates set forth in the table below.

Maximum permissible corrosion rates for scale prevention techniques

| | | welded | | | | | |
|---|---|---|---|---|---|---|---|
| | 90-10 | 90-10 | 70-30 | | | | |
| | CuNi | CuNi | CuNi | Bronze | Copper | Aluminum | Zinc |
| Mils/year | 4 | 4 | 7 | 4 | 4 | 40 | 38 |

As detailed below, all samples met the MIL-PRF-32217 requirements for corrosion (metals).

Results of Metal Corrosion Test for Sample “Freshwater A”

| | | 72 hour corrosion rate |
|---|---|---|
| Material | UNS No./Alloy | (mils/yr) |
| Copper | C10100 | 0.2 |
| Copper | C12200 | 0.2 |
| 90-10 CuNi | C70600 | 0.1 |
| 70-30 CuNi | C71500 | 0.2 |
| 90-10 w/70-30 CuNi | C70600 | 1.2 |
| Bronze | C92200 | 0 |
| Aluminum | N/A | 0.5 |
| Zinc | N/A | 6.5 |

Results of Metal Corrosion Test for Sample “Freshwater B”

| | | 72 hour corrosion rate |
|---|---|---|
| Material | UNS No./Alloy | (mils/yr) |
| Copper | C10100 | 0.2 |
| Copper | C12200 | 0.3 |
| 90-10 CuNi | C70600 | 0.2 |
| 70-30 CuNi | C71500 | 0.2 |
| 90-10 w/70-30 CuNi | C70600 | 0.7 |
| Bronze | C92200 | 0.1 |
| Aluminum | N/A | 0.5 |
| Zinc | N/A | 7.5 |

Results of Metal Corrosion Test for Sample “Seawater A”

| | | 72 hour corrosion rate |
|---|---|---|
| Material | UNS No./Alloy | (mils/yr) |
| Copper | C10100 | 1.1 |
| Copper | C12200 | 1.3 |
| 90-10 CuNi | C70600 | 0.5 |
| 70-30 CuNi | C71500 | 0.4 |
| 90-10 w/70-30 CuNi | C70600 | 0.6 |
| Bronze | C92200 | 0.5 |
| Aluminum | N/A | 1.6 |
| Zinc | N/A | 14.3 |

Results of Metal Corrosion Test for Sample “Seawater B”

| | | 72 hour corrosion rate |
|---|---|---|
| Material | UNS No./Alloy | (mils/yr) |
| Copper | C10100 | 1.2 |
| Copper | C12200 | 1.0 |
| 90-10 CuNi | C70600 | 0.4 |
| 70-30 CuNi | C71500 | 0.5 |
| 90-10 w/70-30 CuNi | C70600 | 0.1 |
| Bronze | C92200 | 0.7 |
| Aluminum | N/A | 1.5 |
| Zinc | N/A | 13.8 |

### Example 4

### Effects on Non-Metallic Materials

A single dose of INTEK-CHTC, as described above, was combined with one gallon of distilled or de-ionized water for the test solution. Pieces of each material were cut into three 25 or 50 mm samples. These samples were then weighted both in air and in water. For the neoprene, buna-n, teflon, viton, EPDM and polyolefin samples, each sample's hardness was measured using a Type O durometer. For the polyvinylchloride (PVC) samples, each sample's hardness was measured using a Type D durometer. The samples were placed in covered jars containing 150 ml of test solution. After 72 hours, the samples were removed from the solution, re-weighed in both air and water, and re-tested for hardness. Upon completion of the testing, the percent volume change of each sample was determined using the following formula V (change in volume)=((M3−M4)−(M1−M2))/(M1−M2), where V change in volume is in percent; M1=initial mass of sample in air, g; M2=initial mass of sample in water, g; M3=mass of specimen in air after immersion, g; and M4=mass of specimen in water after immersion, g. Testing for each material was performed in duplicate test solutions with the solutions identified as “A” and “B”.

The requirements to be achieved were as follows: (1) There shall be no cracking of the surface of the non-metallic specimens detected when inspected under a 7-power magnifying glass, (2) The maximum permissible volume change shall be plus or minus 3.5% when determined using ASTM D471, with the exception that the specimen shall be allowed to equilibrate at ambient conditions for 24 hours prior to measurement, (3) the maximum permissible change in hardness shall be plus or minus 5 points when determined using Durometer and/or Rockwell (ASTM D2240 or ASTM D875) tests before and after exposure.

For the test samples, the results were that A) no cracking of the surface was observed on any of the test samples during visual examination, B) the tables below show the average results of the percent volume change of the three samples tested for each material in solutions “A” and “B”, wherein it is clear that all samples met the requirements stated above for the maximum permissible volume change, and C) all samples met the requirements stated above for the maximum permissible change in hardness. As such, all samples met the MIL-PRF-32217 requirement for effects on non-metallic materials.

Results of Non-Metallic Materials Testing, Test Solution A

| Material | Average change in Volume % |
|---|---|
| Neoprene | 0.12 |
| Buna-N | 0.21 |
| Teflon | −0.04 |
| Viton | −0.22 |
| PVC | −0.08 |
| EPDM | −0.17 |
| Polyolefin | 0.52 |

Results of Non-Metallic Materials Testing, Test Solution B

| Material | Average change in Volume % |
|---|---|
| Neoprene | 0.18 |
| Buna-N | 0 |
| Teflon | −0.03 |
| Viton | 0.12 |
| PVC | −0.02 |
| EPDM | 0.17 |
| Polyolefin | 0.66 |

### Example 5

### Scale Removal

A piping system line with scale was treated with INTEK-CHTC. Visual inspection demonstrated the presence of scale prior to treatment and removal of scale after treatment. Thus, the formulation satisfies the performance criteria set forth above, and is highly effective at scale removal.

While certain embodiments and features of the invention have been illustrated and described herein, many modifications, substitutions, changes, and equivalents will occur to those of ordinary skill in the art. It is therefore to be understood that the appended claims are intended to cover all such modifications and changes as fall within the spirit of the invention.

I hereby claim:

1. A mineral acid free powder formula for inhibiting and removing calcium carbonate scale from freshwater and seawater flushed sanitary systems used on ships and boats, and in land based facilities, including hotels, resorts, and commercial, office, and industrial buildings, comprising:
2-hydroxy-1,2,3,-propanetricarboxylic acid, monohydrate;
2-hydroxy-1,2,3, propanetricarboxylic acid, trisodium salt, dihydrate;
Glycine, N′N′-1,2-ethanediylbis[N-(carboxymethyl)-tetrasodium salt, dihydrate;
one or more corrosion inhibitors; and
optionally, one or more dyes.

2. The mineral acid free powder formula of claim 1 wherein said one or more corrosion inhibitors are selected from the group consisting of 1, 2,3-benzotriazole; a blend of acetylenic alcohols, salts of quaternary amines, and nonionic surfactants; and a blend of substituted triazine (40-50%), ethylene glycol (1-10%), hydrochloric acid (1-10%), thiourea (1-5%), and water.

3. A mineral acid free powder formula for inhibiting and removing calcium carbonate scale from freshwater and seawater flushed sanitary systems used on ships and boats, and in land based facilities, including hotels, resorts, and commercial, office, and industrial buildings, comprising:
a blend of organic acids and organic acid salts;
one or more corrosion inhibitors; and
optionally, one or more dyes.

4. The mineral acid free powder formula of claim 3 wherein said blend of organic acids and organic acid salts includes one or more organic acids or organic acids salts selected from the group consisting of:
2-hydroxy-1,2,3,-propanetricarboxylic acid, monohydrate;
2-hydroxy-1,2,3, propanetricarboxylic acid, trisodium salt, dihydrate;
Glycine, N′N′-1,2-ethanediylbis[N-(carboxymethyl)-tetrasodium salt, dihydrate;
Glycolic acid;
Sulfamic acid;
Ethylenediaminetetraacetic acid;
Nitrilotriacetic acid;
Potassium or sodium salts of glycolic acid;
Glycine, N,N′-1,2-ehtanediylbis[N-(carboxymethyl)-disodium salt;
Glycine, N,N′-1,2-ehtanediylbis[N-(carboxymethyl)-tetrapotassium salt;
Glycine, N,N′-1,2-ehtanediylbis[N-(carboxymethyl)-dipotassium salt;
Potassium or sodium salts of Nitrilotriacetic acid; and
2-Hydroxy-1,2,3-propanetricarboxylic acid, tripotassium salt.

5. The mineral acid free powder formula of claim 3 wherein said one or more corrosion inhibitors are selected from the group consisting of:
a blend of acetylenic alcohols, salts of quaternary amines, and nonionic surfactants;
a blend of substituted triazine (40-50%), ethylene glycol (1-10%), hydrochloric acid (1-10%), thiourea (1-5%), and water;
1,2,3-Benzotriazole;
a blend of alkoxylated fatty amine (proprietary %), alkoxylated organic acid (proprietary %), and thiourea, N,N′-dibutyl (20-30%);
a blend of ethylene dihydroiodide (1-10%), iodine complex (1-10%), phosphoric acid (1-10%), surfactants (1-10%), and water;
tolyltriazole, sodium salt; and
an acetylenic alcohol-based inhibitor.
